(19) United States
(12) Patent Application Publication
(10) Pub. No.: US 2003/0084461 A1
(43) Pub. Date: May 1, 2003

(54) Method and apparatus for transmitting non-VOD services

(76) Inventor: Khoi Hoang, Pleasanton, CA (US)

Correspondence Address: Brian R. Coleman, OPPENHEIMER WOLFF & DONNELLY LLP, 1400 Page Mill Road, Palo Alto, CA, 94304, US

(21) Appl. No.: 10/003,642

(22) Filed: Oct. 25, 2001

(51) Int. Cl. H04N 7/16

(52) U.S. Cl. 725/145; 725/146

(57) ABSTRACT

A method of retrieving data files broadcast repetitively over at least a first time interval and a second time interval comprising, receiving a file request from a user selecting at least one of the broadcast data files, requesting an authorization for retrieval of the file requested, initiating an authorized file retrieval process to retrieve at least a first part of the data file broadcast during the first time interval, and subsequently retrieving a second part of the data file broadcast during the second time interval, and rearranging the first and second parts to reconstitute at least a part of the data file.

### BRIEF DESCRIPTION OF THE INVENTION

1. Field of the Invention

The present application is related to the patent application entitled “UNIVERSAL STB ARCHITECTURES AND CONTROL METHODS,” Ser. No. 09/870,879, by the same inventor Mr. Khoi Hoang, and filed on May 30, 2001, and herein incorporated by reference.

2. Background of the Invention

Prior Art FIG. 1 shows a simplified prior art functional block diagram of a Video On Demand (VOD) system 10. A user at a display screen such as a television 12 makes a selection of a video listed on an electronic program guide (EPG) and places his order for the movie using Set Top Box (STB) 14. The STB 14 is able to communicate via a bi-directional network connection to through a wide area network such as the Internet, to the VOD server 18. Once the VOD server 18 receives the request from the user (viewer) 12, it accesses a bank of disk arrays storing the video selections available in the EPG, and retrieves the selected video and transmits the video to the user over a distribution network. This typical bi-directional distribution infrastructure may consist of any combination of a telephone network and/or a cable TV system. In transmitting the selected video, the video data may be encoded based on any suitable protocol necessary to achieve maximum efficiency for the overall system.

Prior art FIG. 2 is simplified functional block diagram of a prior art STB. Once the user's request is processed by the video server, the corresponding data is transmitted to the user STB. A typical prior art STB may channel the incoming transport stream to a demodulator 20 in order to demodulate the incoming signal. The demodulated signal is then separated into its distinct components by the transport stream demux 22. The video data component of the incoming stream is decoded by the video decoder 24 and the audio data component is decoded by the audio decoder 26. The incoming transport stream also provides timing information used by the clock control unit 28. The clock control unit 28 provides a timing output used to correspond or synchronize the video data to the corresponding audio data.

Prior art FIG. 3 is a block diagram of a prior art method for VOD transmission over a network. In order for the user to select a particular video, an EPG including the available selection and timing must be provided to the user. In step 30, the STB of the prior art may tune into the appropriate channel and receive the transmitted EPG. Next, in step 32, the STB provides the EPG to the user for his viewing. In step 34, the user input is transmitted to a video server in the form of a demand for a particular video. The STB then tunes to the appropriate channel or allocated bandwidth in anticipation of receiving the requested data. In step 38, the client requested data is received by the STB and provided to the client in the form of displayable images after having demodulated, demultiplexed and decoded the incoming signals. Typically, a prior art system may have download rates of 12 Mb/s to 15 Mb/s. For a VOD file, the download speed has to be fast enough to allow real-time playing of the video.

There are some prior art systems that enable the user to instantly play back live TV action. These systems are mostly analog systems (the incoming signal is an analog signal) that receive the transmitted signal at the same rate as they have to display the signals. The signals are converted to a digital equivalent and stored on a local storage medium in order to enable replays. Some of the newer STB systems are capable to receiving a digital signal. However, these systems are only capable of receiving incoming signals at the same rate as the encoding rate, the download rate and the display. Some local storage capacity enables the STB to store and replay the incoming signals

There are many disadvantages to the prior art method and apparatus of transmission and reception of video on demand. Most of the prior art systems are based on the traditional client-server architecture and require a server to service each client request individually. The systems require a broad bandwidth and are limited in the number of clients they can service at each time by the bandwidth requirements. Furthermore, the transmission methods of the prior art fail to take advantage of the capabilities and processing power of the new STBs that have the intelligence to download files using more flexible and efficient algorithms.

Therefore, it is desirable to provide a more bandwidth efficient method of downloading data files by taking advantage of intelligent STB capabilities such as by processing transmitted data using more complicated protocols.

### SUMMARY OF THE INVENTION

Briefly, one aspect of the present invention is embodied in a method of retrieving data files broadcast repetitively over at least a first time interval and a second time interval comprising, receiving a file request from a user selecting at least one of the broadcast data files, requesting an authorization for retrieval of the file requested, initiating an authorized file retrieval process to retrieve at least a first part of the data file broadcast during the first time interval, and subsequently retrieving a second part of the data file broadcast during the second time interval, and rearranging the first and second parts to reconstitute at least a part of the data file.

Another embodiment of the present invention teaches a method for storing data files broadcast repetitively over a transmission medium for future access, comprising, requesting an authorization to use a selected data file, receiving at least a portion of a plurality of said selected data files, said plurality including a first transmission of said selected data file and a second transmission of said selected data file, wherein said portion includes an end portion of said first transmission of said selected data file and a beginning portion of said second transmission of said selected data file, receiving an authorization to use said selected data file, initiating an authorized data file storage process to store said end portion and said beginning portion such that said end portion and said beginning portion form a complete data file.

### BRIEF DESCRIPTION OF THE DRAWINGS

Prior art FIG. 1 is a simplified functional block diagram of a VOD system;

Prior art FIG. 2 is a simplified functional block diagram of a prior art STB;

Prior art FIG. 3 is a block diagram of a prior art method of VOD transmission over a network;

FIG. 4 is a simplified block diagram of a transmission server according to one embodiment of the present invention;

FIG. 5 illustrates a simplified operational block diagram of an intelligent STB device according to one embodiment of the present invention;

FIG. 6 is a block diagram of the operation of a non-VOD client according to one embodiment of the present invention;

FIG. 7 is an illustration of an exemplary broadcast of two separate files within a channel;

FIG. 8 is a block diagram of the operation of another embodiment of a non-VOD client according to one embodiment of the present invention;

FIG. 9 is a block diagram of the operation of a central sever according to one embodiment of the present invention;

FIG. 10 is a block diagram of the operation of a non-VOD client according to one embodiment of the present invention.

### DETAILED DESCRIPTION OF THE INVENTION

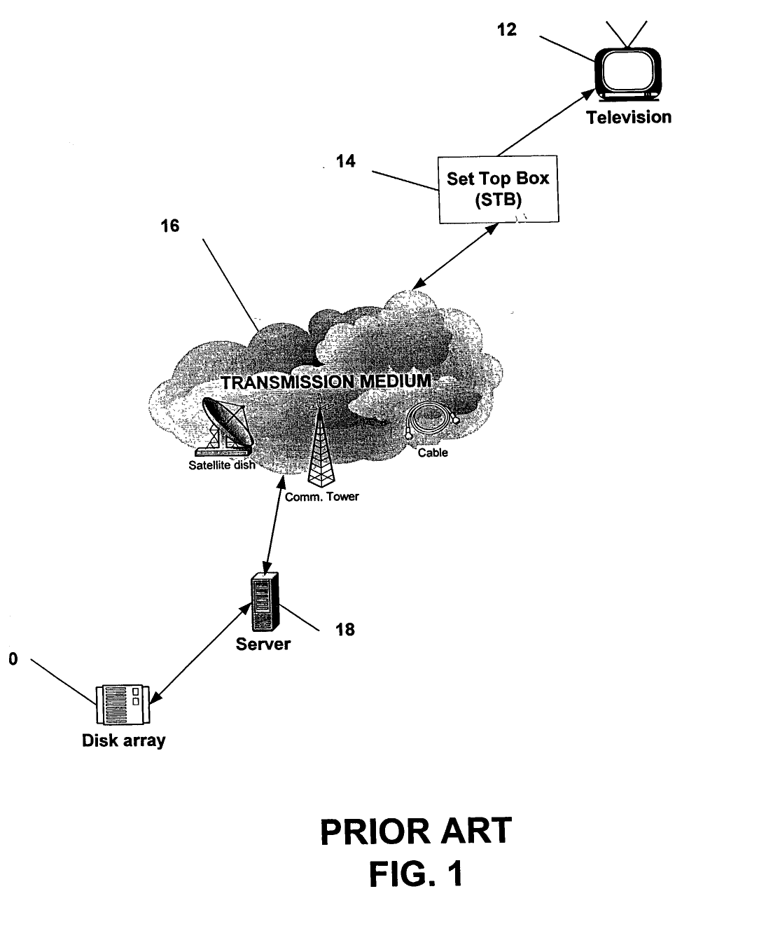

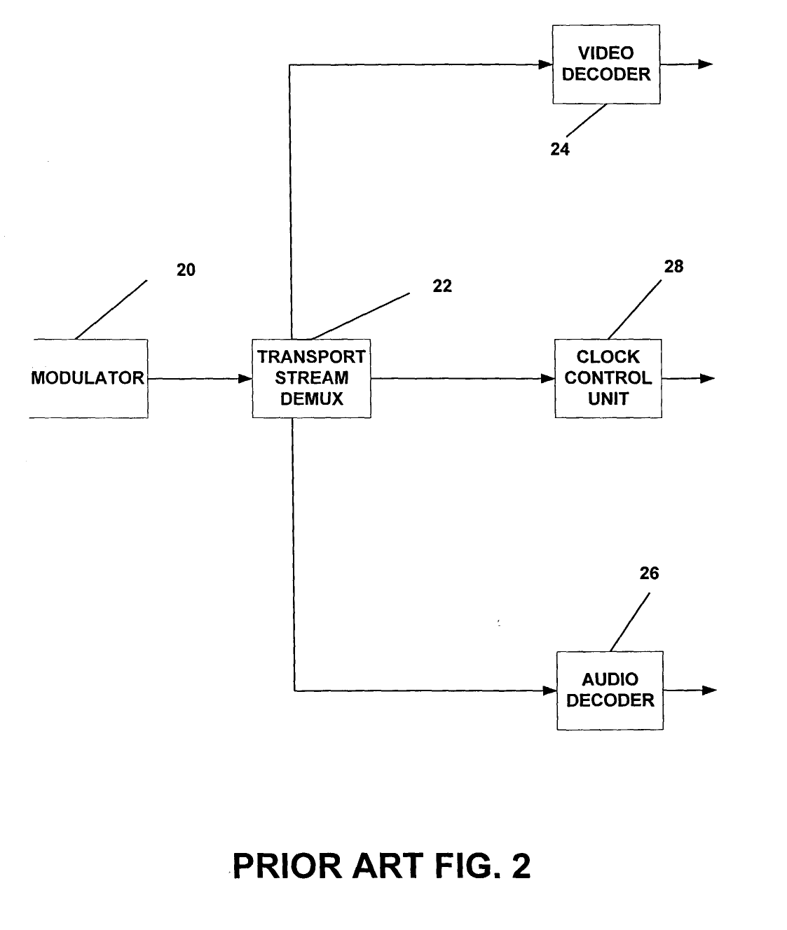

FIG. 4 is a simplified block diagram of a transmission server according to one embodiment of the present invention. The transmission server 39 as shown in FIG. 4 includes a plurality of video sources 40 providing video data. The video data may be generated real-time from a broadcaster or may be retrieved from a storage system. The video feed coming from the video source 40 is encoded into a suitable protocol. In one embodiment of the present invention, the video data is encoded according to an MPEG-2 standard by a plurality of MPEG-2 decoders 42. The encoded video data may be input to a data merger 44 which merges the data from several video sources into one data stream. The output of data merger 44 may feed the merged data to a channel server 48. In accordance with one embodiment of the present invention, each channel server may include a central processing unit (CPU), a Quadrature Amplitude Modulation (QAM) modulator, a local memory, and a network interface. The server controller 50 controls the overall operation of the channel server 48 by instructing the CPU to divide the data files into blocks and further into sub-blocks and data packets, and selecting a particular data block for transmission in accordance with a delivery matrix provided by the central controlling server. The selected data may also be encoded, and compressed by the channel server prior to delivering the data to the combiner/amplifier 56.

In another embodiment of the present invention, the transmission server 39 may include a differently configured central controlling server 50 and a central storage 52. The central controlling server 50 may control the operation of the data merger devices 44 and the channel server devices 46. The central storage device 52 is coupled to the rest of the system through the data bus 58. The combiner/amplifier 56 prepares the data for transmission to the STBs.

It would be obvious to one skilled in the art that the choices for various modulation techniques and/or the selection of an encoding protocol exemplary illustrations and the scope of the teachings of the present invention is not limited to the examples described here.

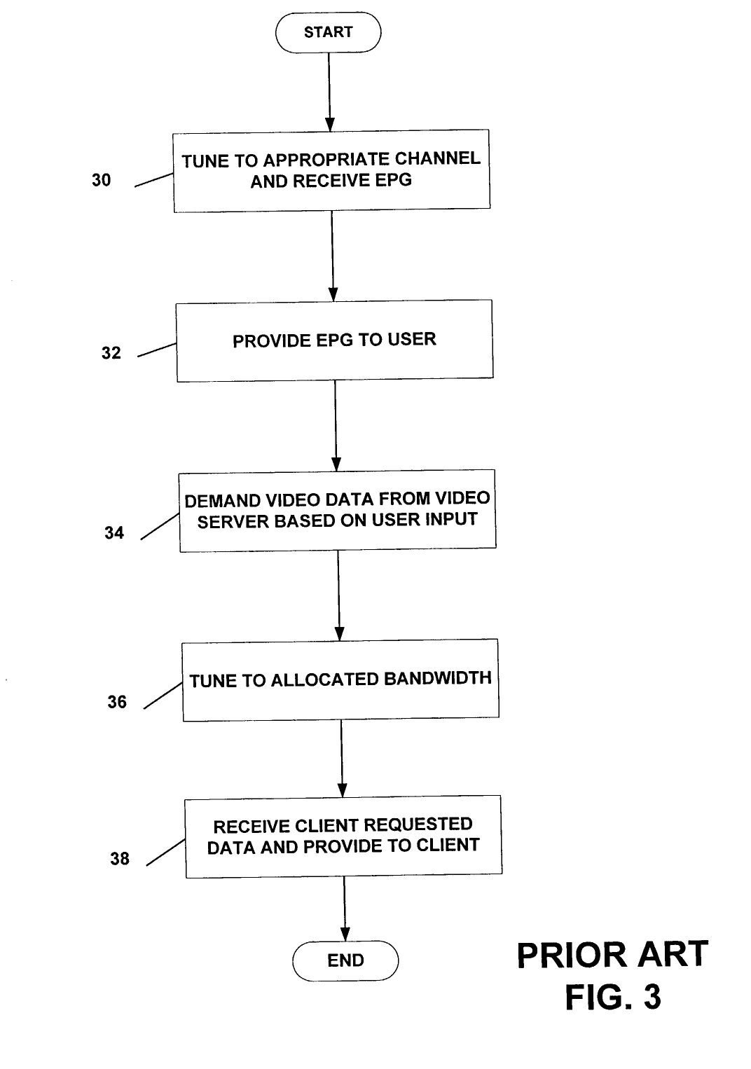

FIG. 5 illustrates a simplified operational block diagram of an intelligent STB device according to one embodiment of the present invention. The transmitted data signals are received and demodulated by the QAM demodulator 62. A central processing unit CPU 64 controls the overall operations of the STB 60. Client requests are processed by the CPU and translated into commands that are transmitted to the video server 39 or are executed within the STB. Commands such as pause, play, rewind and forward may operate on the data already residing in the STB memory 66. The CPU 64 communicates retrieves and processes data stored both in the memory unit 66 and in the buffer memory 69. The STB unit 60 also includes a video decoder 68 and an audio decoder 70 operating on the input data stream, decoding the data packets into a displayable and audibly playable data units ready to be set to output device 72. The decoded data may be temporarily stored in the local memory 66 and the buffer memory 69. A communication link 74 provides additional communications and may be coupled to another computer and/or may be used to implement bi-directional communication. User input may be solicited through a user interface module that provides user inputs to the CPU 64 for further processing. A graphics overlay engine 78 may also be included within the STB 60, allowing for the local rendering and overlaying of graphics with the incoming data stream. A fast data bus 80 may be supplying the communication between the various modules of the STB.

In an exemplary embodiment of the present invention, data broadcast to all cable television subscribers is accessed by the subscribers with adequate permission and the correct equipment. Permission may be granted on a per unit or on a subscription basis wherein the user may access predetermined or unlimited number of movies for a given period of time by paying a flat subscription fee.

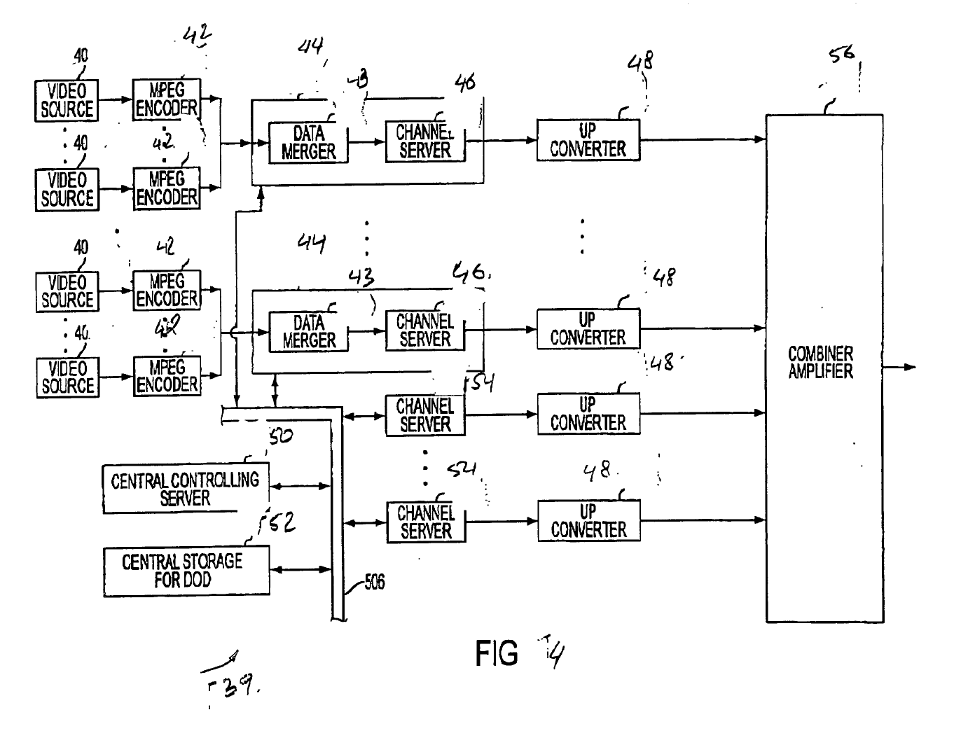

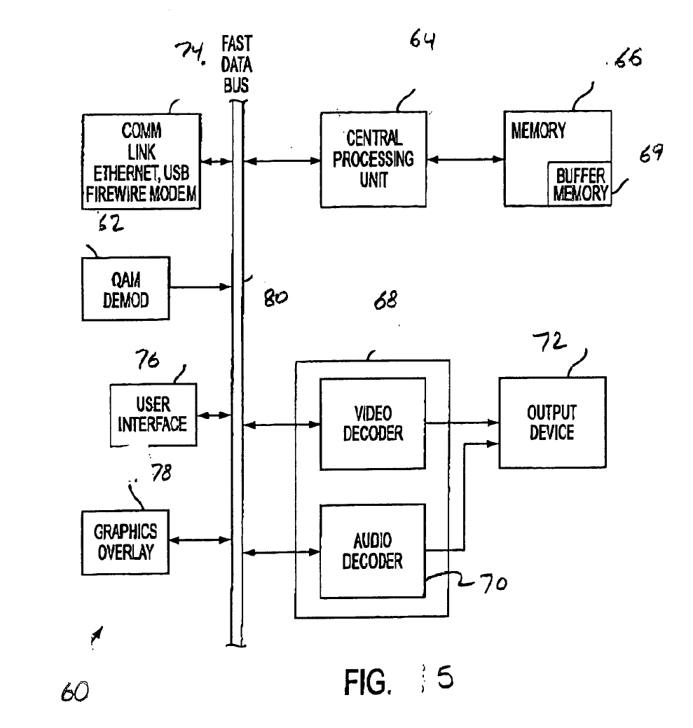

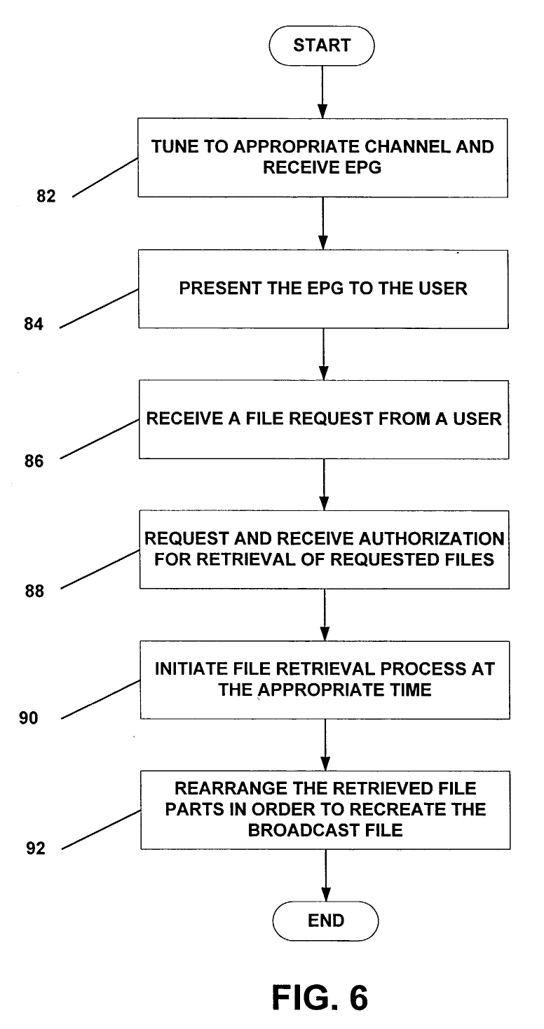

FIG. 6 is a block diagram of the operation of a non-VOD client according to one embodiment of the present invention. In step 82, the intelligent STB may tune to the appropriate channel and receive the EPG. The EPG may provide the list of titles available, the length of the movie, the download time based on a particular download rate, the broadcasting times, the price of the movie title and other such data. The download times for a video file may be dependent on the encoding/decoding bit rate, the bandwidth available, and the number of movies to be downloaded. The table below shows an example of the relationship between the bit rate, the allocated bandwidth, the number of movies to be downloaded and the download time for the movies.

TABLE 1

| | | Number of | |
|---|---|---|---|
| Bit Rate (Mb/s) | Bandwidth (MHz) | movies | Download time (hrs) |
| 0.8 | 0.5 | 72 | 2.4 |
| 0.8 | 1 | 36 | 1.2 |
| 1 | 1 | 36 | 1.5 |
| 1 | 2 | 18 | 1.0 |
| 1.5 | 1 | 36 | 2.3 |
| 1.5 | 2 | 18 | 1.1 |
| 2 | 1 | 36 | 3.0 |
| 2 | 2 | 18 | 1.5 |

The bit rate may refer to the encoding rate of a movie file which would also correspond to the playback rate. The encoding rate varies among different protocols such as MPEG-2 with a lowest encoding rate of 2 Mb/s, MPEG-1 with an encoding rate or bit rate of as low as 0.25 Mb/s, or MPEG-4 with bit rates as low as several hundred Kb/s. Importantly, picture quality deteriorates as the bit rate increases. Moreover, picture quality deteriorates as the corresponding replay rate is reduced below a threshold.

The download rate or the transmission rate along with the bandwidth determine the download time necessary for a given file size. The system of the present invention is capable of supporting a transmission rate that may be independent of the encoding or playback rate. Furthermore, each sub-channel of the system may be used to transmit data at a different rate. Thus, the intelligent STB may download data from various sub-channels within the same channel simultaneously, while the data is being broadcast at different rates.

In an alternative embodiment, the STB may have two or more tuners and thus be capable of tuning and downloading from two or more different channels simultaneously.

As shown in Table 1, for a given transmission standard and the associated encoding rate, the transmission rate may be much lower than the prior art transmission rate of over 12 Mb/s. This low transmission rate requires a lower bandwidth but a less download time. However, as an alternative mode of transmission and possibly a more expensive mode of transmission and download, more types of data may be transmitted over the same channel. For example, assuming that the desired files are movie titles encoded to MPEG-2 format, at 2 Mb/s, a bandwidth of 1 Mb/s per movie allocation of a channel bandwidth of 36 Mb/s, and ten channels associated with this mode of transmission, up to 36 movie titles may be transmitted per channel or 360 titles may be transmitted over ten channels. The lower transmission rate allows the user of a narrower sub-channel bandwidth the capability to transmit a greater variety of files over the same bandwidth.

It would be apparent to one skilled in the art that any reasonable bit rate and download time may be selected to implement the transmission and reception system of the present invention. Currently, MPEG-2 with a lowest bit rate of 2 Mb/s and MPEG-1 with a lowest bit rate of 0.25 Mb/s are most prolifically used. MPEG-4 standard with bit rates as low as several hundred Kb/s or other encoding/decoding standards may be used. However, it should be noted that the lower bit rate decoding might result in lower quality graphics.

Returning to FIG. 6, in step 84, the STB presents the EPG to the user. In step 86, the STB may receive a user input reflecting the selection of the desired titles and the time for download time is received. In one embodiment, once the user has made his selection of the movie title, the STB automatically presents the times that the title is available for download. The user may make his selection based on the EPG information presented to him. In another embodiment, the STB may automatically calculate the minimum download window length necessary based on the longest download necessary. In step 88, the STB communicates the user's selections to the central server by sending a request via a telephone modem or an uplink, and requests an authorization to download the selected files. Once the user selections are processed by the video server, the user's account is charged and an authorization is sent to the STB. In one embodiment, the user pays a subscription fee and the file server verifies that the user's account is up-to-date. In an alternative embodiment, the user's account is debited to reflect the files requested.

In step 90, after receiving authorization from the file server, the STB initiates the file retrieval process at the appropriate time. In one embodiment, the appropriate time to download the requested files is selected by the user. In anther embodiment, the download time is selected automatically by the intelligent STB from the broadcast table presented in the EPG. In most cases, the initiation of the download time does not coincide with the start of the re-broadcast for a particular title. At the end of the first broadcast period for a given file, the intelligent STB continues to download data that was not downloaded in the first download period. For example, the STB may first download data corresponding to the last quarter of the data stream for the file, and subsequently download the first three quarter of data in a second broadcast time interval.

In step 92, once the intelligent STB has downloaded all the data that corresponding to a data file, it rearranges the retrieved data parts in order to recreate the requested and downloaded file. In an alternative embodiment, the rearranging of the data may start while the data is being downloaded.

In one embodiment of the present invention, additional available channels may be used to provide non-VOD services, requiring less bandwidth per video file and capable of delivering more video files to an unlimited number of subscribers and generate additional revenue from the movie library. As shown in Table 1, a 36 Mb/s channel bandwidth may be capable of transmitting 36 video files each using 1 Mb/s bandwidth. As an example, if the video files were encoded to an MPEG-2 format, at 2 Mb/s, the download time would increase to 3 hours.

Many alternative channel allocation schemes may be used in order to accomplish the needs of particular broadcasting scenarios. Although the teaching of the present invention may be practiced with most of these alternative scenarios, practical considerations may lead to a better broadcasting scenario for some selection of parameters. For example, the use of a lower encoding rate allows for lower bandwidth requirements, but a lesser quality may result. Some files (e.g. distant learning programs), however, may have a satisfactory quality even at the lower bit rates. As a result, scenarios can be envisioned where a mix of various types of files share a finite bandwidth and where the bandwidth allocation is based on the type of files broadcast through the particular channel.

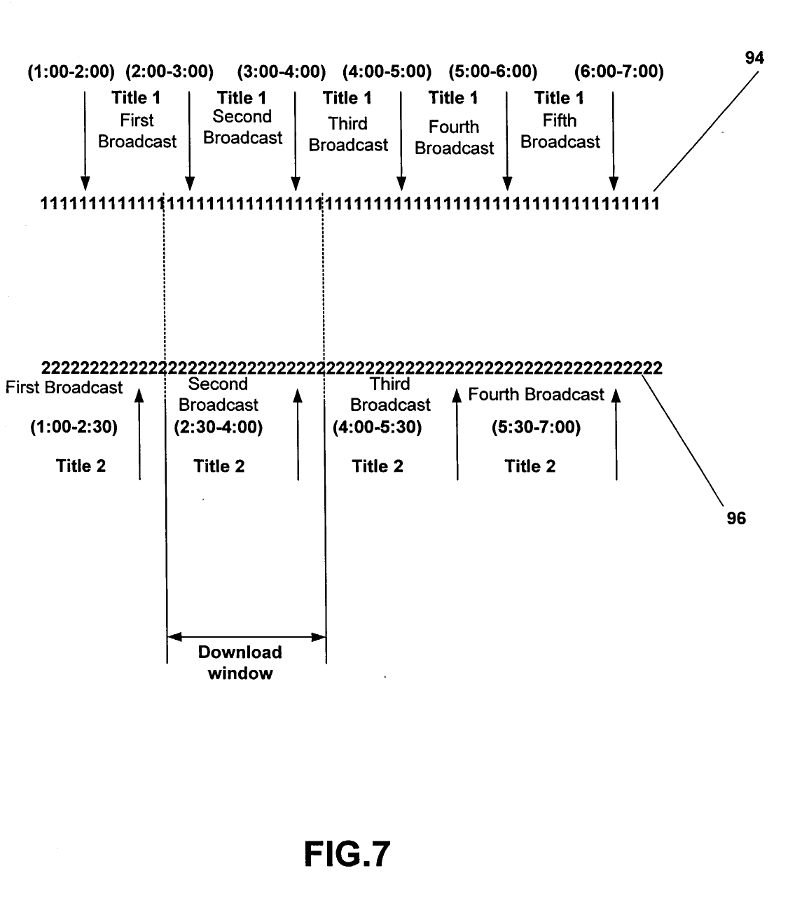

FIG. 7 is an illustration of an exemplary broadcast of two separate files within a given channel. In this example, two movie titles are being broadcast periodically within a given channel. The first movie title 94 has a length of one hour and the second movie title 94 has a length of one and half hours. Each movie is periodically broadcast over its allocated bandwidth. When a user makes his selection from the EPG, the only restriction on his selection is the download time or the download window. The download time must be equal to or longer than the time necessary to download the longest movie. In one embodiment, the user selects a desire download time, and STB may automatically determine from the EPG information, when the selected titles are available and may calculate the window length necessary to download the longest movie title from the selected list.

Once the desired titles are selected and the download window is set, the STB is able to start the download of the selected files at the desired time. Although the desired time may not coincide with the start of a broadcast period, the intelligent STB is capable of downloading and saving a first portion of data corresponding to each of the two selected video files 92 and 94, as they are being broadcast in their corresponding bandwidth. The STB can download the missing data corresponding to each of the selected titles during the next periodic broadcast and combine the downloaded data with the saved data corresponding to a given title to reassemble the whole file.

For a given number of available channels, the number of files that can be downloaded simultaneously by the STB may be limited by the CPU power and storage capacity of the STB.

During the downloading of these non-VOD titles, the STB can playback the recorded materials such as stored VOD movies, and recorded Digital Broadcast programs, if the number of downloaded titles are not over a limit consuming the STB's CPU and storage capabilities. The EPG may be downloaded in a very short time and the download may occur during specially selected times (e.g. midnight) so that it would have no user-noticeable deterioration of STB performance.

In one embodiment, the STB may download all the files that may be available for download within that download window. The factors limiting the number of files that may be downloaded at a given time may be the STB's CPU processing capabilities, the internal STB hardware bandwidth, and the storage capacity of the STB hardware.

It would be apparent to one skilled in the art that the teachings of the present invention may be applied to many different types of files and many different types of file distribution systems.

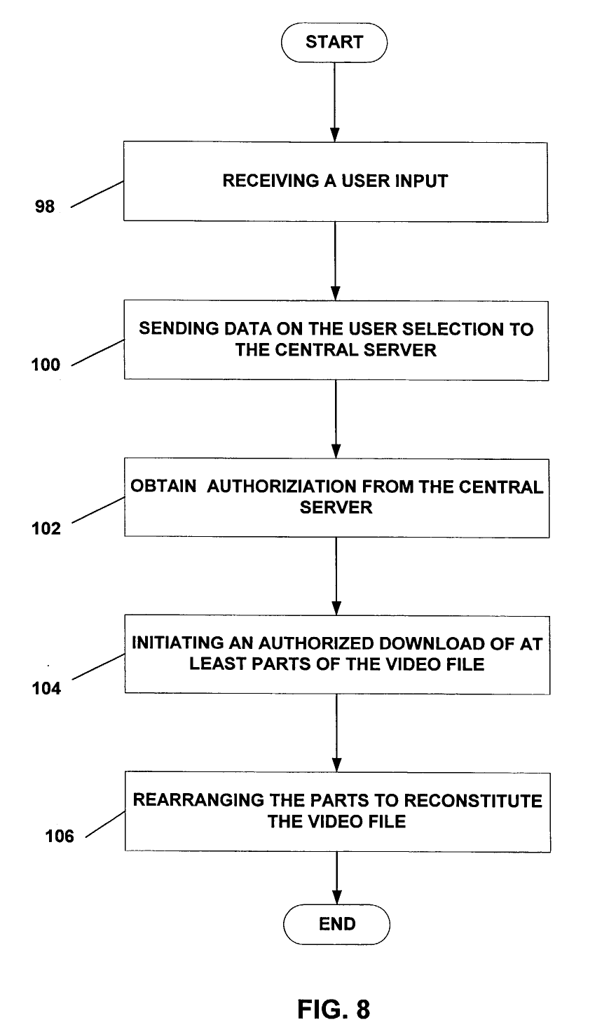

FIG. 8 is a block diagram of the operation of another embodiment of a non-VOD client according to one embodiment of the present invention. In step 98, the intelligent STB receives the user input selecting the movie title to be downloaded. In step 100, the intelligent STB sends data corresponding to the user selection to a central server. In one embodiment of the present invention, the data provided to the central server is used to charge the user account for the selected movie titles. In another embodiment, the user selection data is used to check the user's account status and generate an authorization key or code used by the intelligent STB to access the broadcast streams. In step 102, the intelligent STB obtains an authorization from the central server to access and download the user selected files. In step 104, the intelligent STB initiates an authorized download of at least part of the video file. Since the start of the download time does not necessarily coincide with beginning of the broadcast of a particular title, the intelligent STB would start its download of the requested files midstream. At the end of the first broadcasting period, the intelligent STB continues to download the rest of the data for a particular requested file by downloading the missing data during subsequent broadcasts of the particular file. In step 106, the intelligent STB rearranges the downloaded parts in the right order in order to reconstitutes the requested video file.

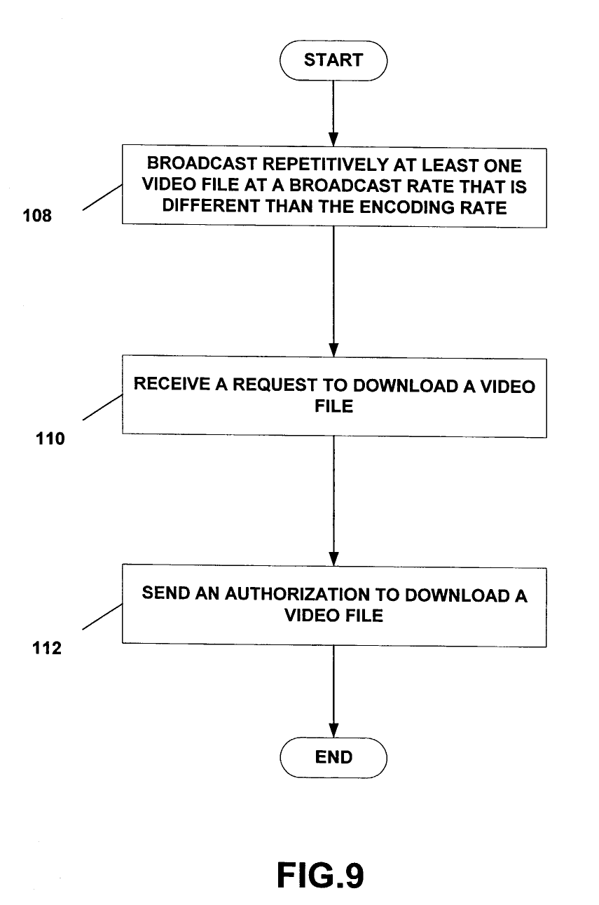

FIG. 9 is a block diagram of the operation of a central sever according to one embodiment of the present invention. In step 108, the central server broadcasts at least one video file repetitively over a predetermined bandwidth. In step 110, the central server receives a request for authorization to download from an intelligent STB client. In step 112, the central server sends the authorization to download to the requesting client. Simultaneously or shortly thereafter, the central server debits the user account for the requested movie titles.

In an alternative embodiment, the user pays a periodic subscription and access fee, and the central server checks to see if the account is paid and up-to-date before granting authorization to access the broadcast streams.

In yet another embodiment, it may not be necessary to contact the central system that broadcasts the selected data files. For example, in one scenario, the user may subscribe to a service level that authorizes him to download any title without any restriction and thus the user STB does not need to contact the central system for any authorization or account debiting. In another scenario, some titles may still be supplied on a pay per use basis and thus even at the highest subscription level, the STB must communicate with the central server. In yet anther scenario, prepaid smart cards may be used to activate the STB and authorize access to the broadcast data. In this scenario, the STB may maintain the bookkeeping necessary to debit the smart card based on usage and no communication with the central server is necessary.

In another embodiment, the STB may communicate with the central server outside of the real-time window of operation, not necessarily to obtain access authorization, but to authenticate itself as an approved STB. This feature may be used in fighting counterfeit STBs. It would be apparent to one skilled in the art that a variety of these implementation schemes may exist side-by-side depending on non technical factors such as marketing and sales programs and other factors.

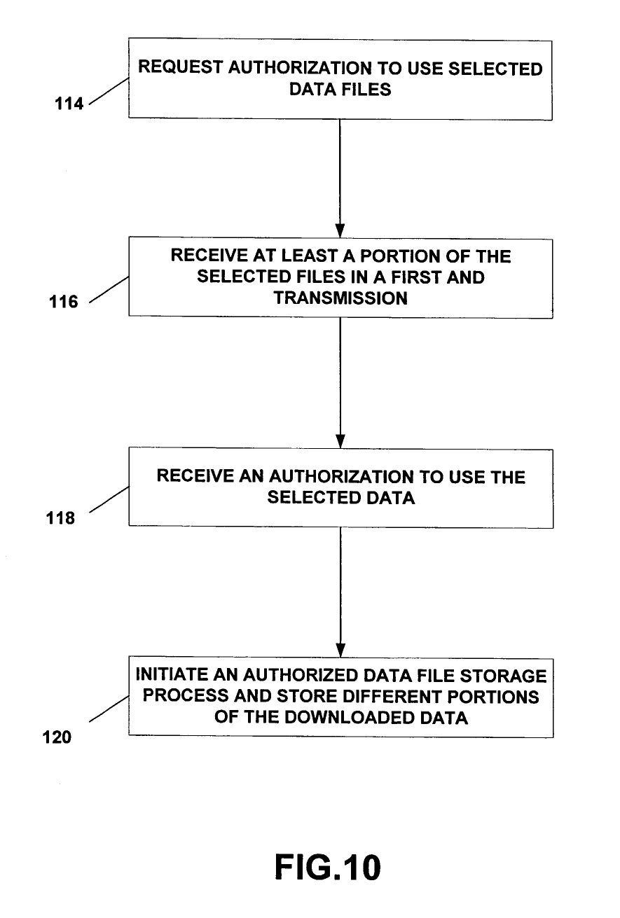

FIG. 10 is a block diagram of the operation of a non-VOD client according to one embodiment of the present invention. In step 114, the STB requests an authorization to use a selected data file. In one embodiment, the request for permission may be presented in real-time prior to accessing the data or prior to downloading the data. In another embodiment, the authorization is done offline as payment of a subscription that entitles the user to a predetermined level of service. The STB may have to check a database on the central server, or read identifying information from the data to be downloaded in order to check the authorization of its user to access the selected data.

In step 116, the STB may receive at least a portion of the selected data files. In one embodiment, the STB may access and simultaneously download data from any given number of sub-channels based on the user's selection. In an alternative embodiment, the STB has more than one tuner and may access data within different channels. The STB accesses the data stream at a pre-determined time which may not coincide with the beginning of a broadcast interval corresponding to the selected data. Therefore, the STB may download different portions of the data at different times within the download window. The length of the download window must be longer than the longest download time necessary to download that file. Alternatively, where simultaneous downloading of several files is not possible, the download window must be equal or longer than the combined download time of all the files to be downloaded. In one embodiment, the download widow is automatically calculated by the STB from the information available in the EPG. In another embodiment, the user may select the length of the download window. If the selected download window is adequate, all the data for a selected file may be downloaded within a single download window. The downloaded data may be out of order. In one embodiment, the data packets within the broadcast data stream have identifiers or meta data that enables the STB to place the downloaded data in the proper sequence in real-time as the data is being downloaded. In another embodiment, the downloaded data is sorted after the download is complete.

In step 118, the STB receives an authorization to store or otherwise use the selected data. In one embodiment, the authorization is obtained prior to download but in real-time. In an alternative embodiment, the authorization is received offline in the form of a general authorization to access a certain level of service based on the user's service level agreement and the payment status of his subscription account.

In step 120, the STB initiates an authorized data storage wherein the downloaded data is arranged and stored in the appropriate sequence to recreate the selected broadcast data file.

It would be apparent to one skilled in the art that the implementation of the teachings of the present invention is not limited to video files and the broadcasting and downloading systems and methods of the present invention may be applied to different mediums and different data types and files and different services.

The foregoing examples illustrate certain exemplary embodiments of the invention from which other embodiments, variations, and modifications will be apparent to those skilled in the art. The invention should therefore not be limited to the particular embodiments discussed above, but rather is defined by the following claims.

We claim:

1. A method of retrieving repetitively broadcast data files over at least a first time interval and a second time interval comprising:
receiving a file request from a user selecting at least one of the repetitively broadcast data files;
initiating an authorized file retrieval process to retrieve at least a first part of the repetitively broadcast data file during the first time interval, and subsequently retrieving a second part of the repetitively broadcast data file during the second time interval; and
rearranging the first and second parts to reconstitute at least a part of the repetitively broadcast data file.

2. The method of claim 1 further comprising requesting an authorization for retrieval of the file requested.

3. The method of claim 1 further comprising:
retrieving a third part of the data file broadcast during a third time interval; and
rearranging the first, second and third parts to reconstitute the complete data file.

4. The method of claim 1 wherein different types of files are broadcast in each of a plurality of sub-channels within a given channel, and wherein each file has a different rate of broadcast.

5. The method of claim 1 wherein an EPG is received by a user STB and presented to the user.

6. The method of claim 5 wherein the user STB automatically selects a download time from an EPG corresponding to the file selected by the user, each file including data corresponding to at least a download interval.

7. The method of claim 5 wherein the user STB automatically calculates the download window length using an EPG.

8. The method of claim 7 wherein the download window length is longer than the longest broadcast interval corresponding to the largest file.

9. A computer program product embodied in a computer readable medium for retrieving repetitively broadcast data files over at least a first time interval and a second time interval comprising:
code means for receiving a file request from a user selecting at least one of the broadcast data files;
code means for initiating an authorized file retrieval process to retrieve at least a first part of the data file broadcast during the first time interval, and subsequently retrieving a second part of the data file broadcast during the second time interval; and
code means for rearranging the first and second parts to reconstitute at least a part of the data file.

10. The computer program product of claim 9 further comprising requesting an authorization for retrieval of the file requested.

11. The computer program product of claim 9 further comprising:
code means for retrieving a third part of the data file broadcast during a third time interval; and
code means for rearranging the first, second and third parts to reconstitutes the complete data file.

12. The computer program product of claim 9 wherein different types of file may be broadcast in each sub-channel within a given channel, and wherein each file has a different broadcast rate.

13. The computer program method of claim 9 wherein an EPG is received by a user STB and presented to the user.

14. The computer program product of claim 13 wherein the user STB automatically selects a download time from an EPG corresponding to the file selection by the user, each file including data corresponding to at least a download interval.

15. The computer program product of claim 13 wherein the user STB automatically calculates the download window length using an EPG.

16. The computer program product of claim 15 wherein the download window length is longer than the longest broadcast interval corresponding to the largest file.

17. An apparatus for retrieving data files broadcast repetitively over at least a first time interval and a second time interval comprising:
means for receiving a file request from a user selecting at least one of the broadcast data files;
means for initiating an authorized file retrieval process to retrieve at least a first part of the data file broadcast during the first time interval, and subsequently retrieving a second part of the data file broadcast during the second time interval; and
means for rearranging the first and second parts to reconstitute at least a part of the data file.

18. The apparatus of claim 17 further comprising requesting an authorization for retrieval of the file requested.

19. The apparatus of claim 17 further comprising:
means for retrieving a third part of the data file broadcast during a third time interval; and
means for rearranging the first, second and third parts to reconstitutes the complete data file.

20. The apparatus of claim 17 wherein different types of file may be broadcast in each sub-channel within a given channel, and wherein each file has a different broadcast rate.

21. The apparatus of claim 17 wherein an EPG is received by a user STB and presented to the user.

22. The apparatus of claim 21 wherein the user STB automatically selects a download time from an EPG corresponding to the file selection by the user, each file including data corresponding to at least a download interval.

23. The apparatus of claim 21 wherein the user STB automatically calculates the download window length using an EPG.

24. The apparatus of claim 23 wherein the download window length is longer than the longest broadcast interval corresponding to the largest file.

25. A method of downloading video files broadcast periodically, using an intelligent STB comprising:
receiving a user input including at least one selected video file;
sending user selection information to a file server;
obtaining authorization from the file server to download the selected video file;
initiating an authorized download of at least a first part of the selected video file broadcast during the first time interval, and subsequently retrieving a second part of the video file broadcast during the second time interval; and
rearranging the first and second parts to reconstitute at least a part of the video file.

26. The method of claim 25 further comprising:
retrieving additional parts of the video file broadcast during additional time interval; and
rearranging all the parts to reconstitutes the complete video file.

27. A method of supplying video files for download by an intelligent STB comprising:
broadcasting repetitively at least one video file over a predetermined bandwidth wherein the rate of broadcast may be different from the encoding rate, and wherein each of a plurality of sub-channels may operate at a different rate of broadcast.

28. The method of claim 27 further comprising:
receiving a request to download a video file being broadcast repetitively from an intelligent STB; and
sending an authorization to download at least one broadcast video file.

29. The method of claim 27 wherein each video file is broadcast continuously.

30. The method of claim 27 wherein the within a given channel, video files with different encoding rate are broadcast over different bandwidths.

31. The method of claim 27 wherein several video files are broadcast over the same bandwidth.

32. A system for supplying video files for download by an intelligent STB comprising:
means for broadcasting repetitively at least one video file over a predetermined bandwidth;
means for receiving a request to download a video file being broadcast repetitively from an intelligent STB;
means for sending an authorization to download at least one broadcast video file; and
means for receiving the authorization to download and downloading the video file.

33. A method for storing data files broadcast repetitively in a over a transmission medium for future access, comprising:
requesting an authorization to use a selected data file;
receiving at least a portion of a plurality of said selected data files, said plurality including a first transmission of said selected data file and a second transmission of said selected data file, wherein said portion includes and end portion of said first transmission of said selected data file and a beginning portion of said second transmission of said selected data file;
receiving an authorization to use said selected data file;
initiating an authorized data file storage process to store said end portion and said beginning portion such that said end portion and said beginning portion forms a complete data file.

34. The method of claim 33 further comprising reconstructing said selected data file from said stored end portion and said beginning portion.

35. The method of claim 33 further comprising constructing a data file substantially similar to said selected data file from said stored end portion and said beginning portion.

36. The method of claim 33 further comprising displaying a visual representation of at least a portion of said complete data file.

37. The method of claim 33, wherein said selected data file is an audio/visual display program.

38. The method of claim 33 wherein said selected data file is an interactive machine executable program.

39. The method of claim 33 wherein said first and second transmissions of said selected data file are encoded to prevent unauthorized access to said selected data file.

40. The method of claim 39 wherein a client set-top-box is used to decipher said encoded selected data file using said authorization.

41. The method of claim 33 further comprising receiving an electronic programming guide (EPG), wherein said requesting an authorization to use a selected data file is facilitated by said EPG.
